(19) United States
(12) Patent Application Publication
(10) Pub. No.: US 2015/0195990 A1
(43) Pub. Date: Jul. 16, 2015

(54) Spray on Demand

(71) Applicant: Joseph B. St.Andre', Lafayette, LA (US)

(72) Inventor: Joseph B. St.Andre', Lafayette, LA (US)

(21) Appl. No.: 14/155,459

(22) Filed: Jan. 15, 2014

(51) Int. Cl. A01C 23/04; A01C 21/00; A01M 9/00; A01C 15/04; A01N 25/00; A01M 7/00

(52) U.S. Cl. CPC A01C 23/047; A01N 25/00; A01M 7/0042; A01M 9/0053; A01C 15/04; A01C 21/00

(57) ABSTRACT

A 12 volt demand pump with an adjustable spray nozzle and/or spray boom attachment and tank, to be permanently incorporated within, and/or permanently attached to any applicable commercial/residential lawn mower, for the purpose of spraying liquid herbicides, fertilizers, pesticides, fungicides, insecticides and/or repellants and/or any fully dissolvable solid herbicides, fertilizers, pesticides, fungicides, insecticides and/or repellants.

### FIELD

The present invention relates to 12 volt pump sprayers and more particularly, to 12 volt pump sprayers which can provide a chosen spray pattern for distribution of liquid herbicides, fertilizers, pesticides, fungicides, insecticides and/or repellants and/or any fully dissolvable solid herbicides, fertilizers, pesticides, fungicides, insecticides and/or repellants while using the applicable commercial/residential lawn mower with permanently attached tank, 12 volt pump, spray nozzle and/or boom attachment, to distribute said products.

### BACKGROUND OF THE INVENTION

It is time consuming for the operator of a commercial/residential lawn mower to cut grass and then to come back and apply herbicides for weed control by spraying through the use of conventional means, ie, manual hand held pump sprayers and/or back pack sprayers. The use of hand held pump sprayers and/or back pack sprayers is exhausting to the operator and/or time consuming to the operator. In addition, the hand held pump sprayer and/or back pack sprayer could cause injury to the user while maneuvering because of the weight of the material being carried and applied. In addition, other removable attachments and/or removable accessories for the lawn mower itself are time consuming, depending upon mounting location, could cause center of gravity issues and/or maneuverability issues.

This invention allows the operator of the commercial/residential lawn mower to distribute said herbicides without having to physically walk the entire perimeter of the desired area and/or a selected area to be treated, thus cutting time and eliminating physical labor. The operator can distribute herbicides while operating the commercial/residential lawn mower in a safe and efficient manner by engaging the permanently installed tank and 12 volt pump sprayer through a hand held spray wand and/or boom. In addition, by using the same spray wand method and/or boom, liquid and/or fully dissolvable solid fertilizers, pesticides, fungicides, insecticides and/or repellants can be applied while the operator is cutting grass and/or applied at any desirable time while operating the lawn mower. Using a demand switch model pump, the pump operates only when liquid flow is required. The pump and motor stop instantly when discharge is closed.

### SUMMARY OF THE INVENTION

The principle of this invention is to provide means for distributing liquid herbicides, fertilizers, pesticides, fungicides, insecticides and/or repellants and/or any fully dissolvable solid herbicides, fertilizers, pesticides, fungicides, insecticides and/or repellants, by allowing the commercial/residential lawn mower operator to immediately place into operation without any delay for the purpose of applying said products without having to connect any attachments or accessories which would be time consuming to the operator and/or potentially unsafe to the operator. A tank and 12 volt pump sprayer is permanently incorporated in the commercial/residential lawn mower with an adjustable spray nozzle and/or spray boom attachment.

### DESCRIPTION OF THE DRAWING FIGURES

FIG. 1 is a top view of all components

### DESCRIPTION OF THE EMBODIMENTS

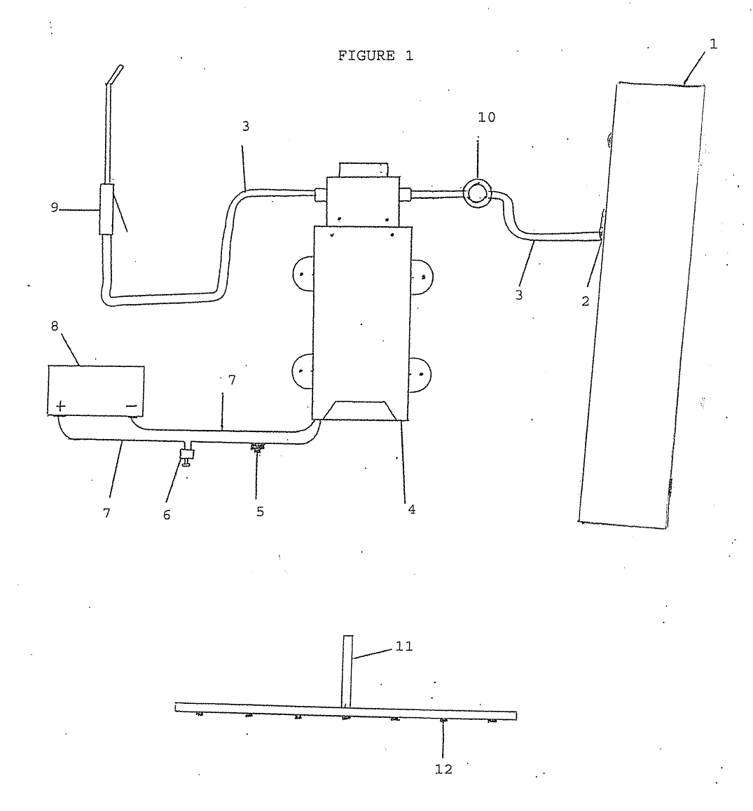

FIG. 1 Top View of All Components, which incorporates the following parts:
Part No. 1 Tank
Part No. 2 Hose Adaptor
Part No. 3 Rubber Hose
Part No. 4 12 Volt Pump
Part No. 5 Inline Fuse
Part No. 6 On/Off Switch
Part No. 7 Positive/Negative Wires
Part No. 8 12 Volt Battery
Part No. 9 Spray Wand
Part No. 10 Inline Strainer
Part No. 11 Optional Boom
Part No. 12 Spray Nozzle for Optional Boom

These are all examples of parts that may be used in the construction of said invention and in achieving the essence of this invention.

The present invention may be constructed, installed and enabled in other ways than those set forth without departing from the essential characteristics of the disclosed invention. Accordingly, the invention is not limited to what which is specifically described in the appended claims. Variations or modifications to the subject invention may occur to those skilled in the art upon reviewing the invention as described herein. Such variations or modifications, if within the spirit of this invention, as described herein, are intended to be encompassed within the scope of any claims provided in this disclosure. The description of the preferred embodiment and parts used, as shown in the attached drawing, is set for illustrative purposes only. While particular embodiments/parts of the present invention have been illustrated and described, it would be obvious to those skilled that various other changes and modifications can be made without departing from the spirit and scope of this invention. It is therefore intended to cover in the claim all such changes and modifications that are within the scope of this invention.

What is claimed is:

1. A method of distributing liquid herbicides, fertilizers, pesticides, fungicides, insecticides and/or repellants and/or any fully dissolvable solid herbicides, fertilizers, pesticides, fungicides, insecticides and/or repellants for the purpose of, including, but not limited to, undesirable weed control, fertilizer application(s) and/or for the control of insects and/or plant fungus.

2. Distribution is achieved through a pump, spray nozzle, spray boom, hoses, hose adaptors, an inline strainer, and tank.

3. Said tank and 12 volt demand pump is permanently attached to and/or incorporated within any applicable commercial/residential lawn mower, and dispensed with an adjustable spray nozzle and/or spray boom; and said tank and 12 volt demand pump being permanently constructed and/or arranged within the body or frame of the lawn mower or attached to the lawn mower in any fashion deemed necessary for safe operation of said mower.
